(19) United States
(12) Patent Application Publication
(10) Pub. No.: US 2023/0179697 A1
(43) Pub. Date: Jun. 8, 2023

(54) PUSH TO TALK RADIO LOCK

(71) Applicant: Rugged Race Products, Inc., Arroyo Grande, CA (US)

(72) Inventor: Greg Cottrell, Arroyo Grande, CA (US)

(21) Appl. No.: 18/076,270

(22) Filed: Dec. 6, 2022

Related U.S. Application Data
(60) Provisional application No. 63/286,667, filed on Dec. 7, 2021.

(51) Int. Cl. H04M 1/60

(52) U.S. Cl. CPC H04M 1/605; H04M 1/6058

(57) ABSTRACT

There is disclosed a communication device. The communications device includes a radio transceiver for transmitting and receiving radio transmissions and a push-to-talk toggle, integral to the communication device, for enabling capture and transmission of audio when the push-to-talk toggle is engaged and for disabling capture and transmission of audio when the push-to-talk toggle is disengaged. The push-to-talk lock toggle is integral to the communication device, and disables capture and transmission of audio and disabling engagement of the push-to-talk toggle while the push-to-talk lock toggle is enabled.

### RELATED APPLICATION INFORMATION

This patent claims priority from U.S. provisional patent application No. 63/286,667 entitled “PUSH TO TALK RADIO LOCK” filed on Dec. 7, 2021.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This invention relates to radio frequency communications and more particularly to systems for avoiding unintentional constant communications using push-to-talk radio broadcast.

### Description of the Related Art

Outdoor activities such as dirt biking, UTVing, off-roading, mountain biking, skiing, and others tend to involve individuals acting in spaces that are remote from typical communications networks such as mobile phones or loudspeakers. Many or most of these activities can be dangerous or involve safety risks for accidents or simply because individuals participate in them in inhospitable areas such as deserts or high-altitude mountains or forests. Also, these activities are often strenuous on the individuals involved and on any equipment such as tires, power trains, suspensions, skis, bike frames, and the like. Finally, the motors or engines sometimes involved can generate a great deal of noise, making it difficult to merely speak to individuals riding along with a driver.

As a result, participants in these kinds of activities tend to rely upon short-range radio frequency communications to communicate with one another. Typically, these radio transceivers are incorporated into safety helmets for the participants. However, other transceivers may be built into headsets worn by individuals, for example, at a basecamp or a race starting point, finishing point, or any number of checkpoints along the way. Handheld radio transceivers are also common, which may be used with or without headsets or earpieces.

The drivers of UTVs (or participants in other activities) will set their radios to the same frequency along with the other riders or participants with whom they wish to communicate. Helmets of a driver and passengers may connect to or integrate with the UTV mounted radio. In this way, everyone involved in the UTVing can communicate with everyone else. If someone is hurt, or their UTV malfunctions or an accident happens, the others can be alerted, and guided to the rescue. More basically, the individual at the basecamp can be kept apprised of the status of the activities, an expected return, and be prepared when they return. In a race scenario, drivers and spotters (the front passenger) can inform race operations for their team of problems with their vehicles in anticipation of pit stops along the way so that repairs may be made, water may be available, or for other purposes to increase the amount of time out having fun or on the course and decrease the downtime.

In other fields such as mountain biking, skiing, dirt biking, and the like, riders or groups of riders may wish to communicate over short distances (e.g. a few miles) quickly and effectively. Those individuals may use helmets incorporating associated radio transceivers. However, these individuals may rely upon handheld radio transceivers (e.g. walkie-talkies). In addition to the participants, those individuals at a home base or lodge, such as spouses, parents, friends, and the like may wish to utilize the same communication channels to communicate, and keep tabs on, those individual on the mountain, engaged in the activity, or the like.

A common occurrence in these cases is that the handheld radio transceivers incorporate a clip for clipping it to the belt or waistband of a user. This is beneficial in that it frees the hands of that user, enables the transceiver to be put away when not in use, but remain close at hand, and enables the use of a headset connected to the handheld transceiver to enable essentially handsfree access to communication as desired.

Radio transceivers in general operate in one of two modes. The first mode is open channel mode. In this mode, all participants are constantly broadcasting as well as receiving all associated audio generated by any other participant tuned to the same frequency. The major positive of this mode is that no communication is missed from any participant. The major downside of this mode is that all participants hear every word or action of any other participant. In most cases, the channel becomes filled with meaningless communication and participants stop listening.

The other mode—and the mode most commonly used—is push-to-talk mode. In this mode, all participants tune to a frequency. The participants can all hear every broadcast by any other participant on that channel at all times. However, a participant who wishes to speak and be heard must first push a button on the headset, handset, helmet, or other device to begin speaking. If a user speaks without pushing a button, it is not captured and is not transmitted to the other individuals on that frequency. This mode avoids needlessly filling the air with empty noise or with random background noise from one or more participants in a given frequency. However, user action is required for any communication to take place.

One drawback of the push-to-talk mode is that users may inadvertently push the push-to-talk button while not intending to do so. And, commonly, particularly with users who clip handsets to their belts, the push-to-talk button may inadvertently always be pushed. This happens quite commonly, for example, when such a user clips the handset to a belt or waistband, then sits somewhere. A pocket, pants, or body may inadvertently hold down the push-to-talk button. Thereafter, the primary benefit of push-to-talk mode is eliminated and all listeners on the selected frequency hear everything near or in the presence of the individual who has inadvertently held down that button.

### DESCRIPTION OF THE DRAWINGS

FIG. 1 is a system overview for a push-to-talk lock for a communications system.

FIG. 2 is a functional block diagram of a communications device.

FIG. 3 is a block diagram of computing device.

FIG. 4 is a flowchart of a method for use of a push-to-talk lock.

FIG. 5 is a flowchart of a method for use of a push-to-talk automatically engaging lock.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously-described element having a reference designator with the same least significant digits.

### DETAILED DESCRIPTION

### Description of Apparatus

In response to the limitations of the prior art, the inventors have developed a solution. Specifically, the push-to-talk button may be “locked” using hardware or using software to ensure that it cannot be simply held down (purposefully or inadvertently) and continuously transmit. Preferably, this function is integrated as a button, a menu item on a front interface of a radio, or as a separate toggle switch on the exterior of the radio. Even more preferably, the toggle, button, or menu item is recessed on the front face to prevent inadvertent interaction with it. It may be set by default to “on” (e.g. preventing holding down the push-to-talk) and may be designed in such a way to prevent inadvertent disengagement of the menu item.

Preferably, this function may be integrated particularly into handheld radio transceivers (e.g. handsets), but the same functionality may be integrated into headsets, integrated helmet transceivers, and other forms of the associated radio transceivers. In basic implementations, physical buttons, toggles, or menu items may be made available on faces of associated devices. In more complex implementations, software may enable these functions in dynamic fashion. For example, software may be able to detect that a given user has been “holding down” the push-to-talk function for longer than a few seconds or longer than a few seconds and that no nearby sounds (e.g. voices) are being transmitted over that frequency. In such a case, the software may automatically silence that participant or may automatically enable a push-to-talk lock to disable push to talk for that user.

While the push-to-talk lock functionality is enabled, there are two options for how it will function. In a first option, only the push-to-talk key may be disabled. In this mode, the other functions and buttons of the associated radio transceiver may function. So, frequencies may be changed, volume may be altered, and other functions of the radio transceivers may operate as normal. But, in this mode, the push-to-talk button will not function unless and until the push-to-talk lock is disabled.

In an alternative mode for the push-to-talk lock or in an alternative implementation, when the push-to-talk lock is enabled, all function changes for the radio transceiver may be disabled. In this way, the user may not inadvertently change the volume, alter the frequency channel being used, or push-to-talk. This may be preferred to the other mode in cases where other buttons are routinely being inadvertently changed or interacted with. With the push-to-talk lock enabled, the user is unlikely to accidently lose the family channel or turn the volume very high or very low. That user can continue to participate in the conversation, while listening, without inadvertently altering the radio transceiver.

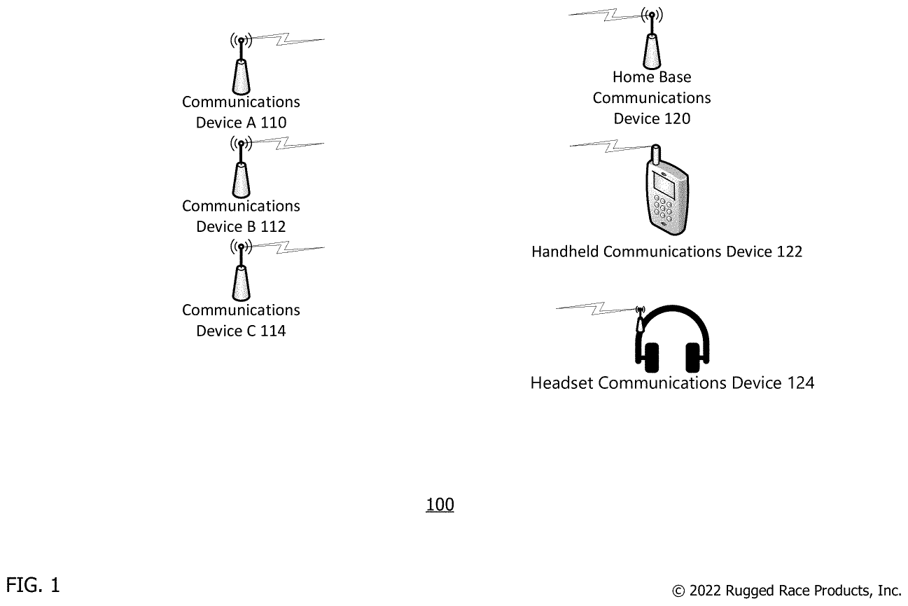

FIG. 1 is a system overview for a push-to-talk lock for a communications system. The system 100 includes a communications device A 110, a communications device B 112, a communications device C 114, a home base communications device 120, a handheld communications device 122, and a headset communications device 124. Though shown as a system 100, in use a given system may include more or fewer of any of the types of communications devices shown and may include devices in other form factors as well such as mobile phones, wrist-won communications devices, or handsfree communications devices.

The communications device A 110, communications device B 112, and communications device C 114 are interchangeable and include the same or substantially the same components and functions. They are representative of devices used in a location remote from the home base communications device 120, but they are intentionally somewhat generic in form. Any one of those devices may be, at a given time, a home base communications device 120. There is no particular aspect of any of these communications devices that set them apart from one another, other than perhaps form factor, portability (e.g. battery or power plug, weight and whether they are worn or held or mounted in another device), and typical use cases. The communications devices A, B, and C 110, 112, and 114 may be, for example, dashboard mounted radio transceivers within UTVs, 4×4 vehicles, or may be bike-mounted communications devices. Other form factors are possible as well.

Each communications device incorporates a radio transceiver, an antenna, a microphone and a speaker, along with associated circuitry to enable the communications devices to communicate with the other devices using radio signals to transmit radio waves representative of audio from one device to another device (or to all devices, if the same channel is selected). These devices are shown as a system 100, but more or fewer of them may be present than depicted.

The home base communications device 120 is a communications device that is used at a location set up as a home base. So, for example, in the case of a UTV experience, the home base communications device 120 may be one fixed within or as a part of a mobile vehicle that is set up as a location to which the UTVs return for lunch, and where a campsite is or where transportation out of the UTV area is available. It may simply be a handheld communications device, a headset or other form factors. But, traditionally, it would be a vehicle-mounted radio communications systems (similar to an old-style CB radio) in or below a dash of the vehicle. Alternatively, it may be set up on a table or in a tent. In other cases, particularly farming or similar scenarios, a home base communications device 120 may be within a residence or agricultural building.

The handheld communications device 122 is a communications device that can be held in the hand. It is typically battery powered and designed for use with one hand. It may incorporate wired or wireless connectivity options such as attaching a traditional 3.5 mm audio jack for use with a headset or earpiece speaker/microphone combination to thereby make the handheld communications device 122 into more of a headset communications device. Though, the handheld communications device 122 typically includes a belt clip or other clip to be attached to the person wearing the wired headset. Wireless headsets are also sometimes used with handheld communications device 122, such as Bluetooth® devices.

The headset communications device 124 is a communications device in a form to be worn on a user's head. The headset communications device 124 typically includes a microphone stalk that extends toward a user's mouth to pick up on audio from the user. The headset communications device 124 may be stand-alone, integrating all the necessary components for wireless radio communications (e.g. transceiver, batteries, microphone, speaker, control buttons, etc.). Or, it may merely be a conduit—through wireless connection—to another device that includes some or all of those components.

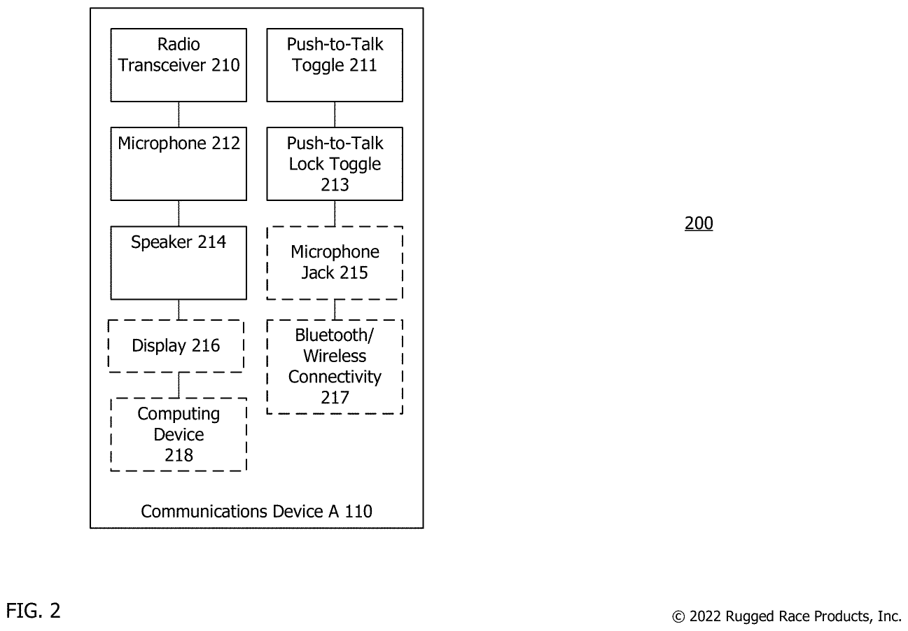

FIG. 2 is a functional block diagram of a communications device 200. The communications device A 110 is shown, but the components shown and discussed may equally be in or in communication with any of the other communication device types shown above. As discussed above, some of these components may be integral to the device while others may be merely in communications with the device 110.

The communications device A 110 includes a radio transceiver 210, a microphone 212, a speaker 214, a push-to-talk toggle 211, a push-to-talk lock toggle 213. The communications device A 110 may also optionally include one or more of a display 216, a computing device 218, a microphone jack 215, and Bluetooth/wireless connectivity 217.

The radio transceiver 210 is a combination receiver and transmitter. In a general sense, these devices have been commonplace since the early 1900s. In a simple form, the transmitter modulates (amplitude and/or frequency) to impart a waveform to the radio waves to thereby add “data” to the radio wave which is then transmitted in the air over distance. The distances vary with the power of the transmitter and the types of radio waves used (e.g. their frequency). For purposes of this application, typically handheld walkie-talkie style radio transceivers transmit and receive in the 27 MHz and the 400-500 Mhz ranges of the UHF spectrum. Other spectrums may be used for other purposes.

The microphone 212 is a microphone used to capture human voice (or other audio) and to convert it into electrical signals for transmission by the transceiver.

The speaker 214 is a speaker used to reproduce the human voice (or other audio) that is received as electrical signals from the transceiver. The speaker enables audio to be heard by a user of a given communications device.

The push-to-talk toggle 211 is a switch, button, software setting, on-display button or setting, or other mechanism used to selectively enable and disable transmission on a selected frequency channel of the radio transceiver 210. The push-to-talk toggle 211 is used to disable all communication by a given communications device unless and until it is activated, depressed, or otherwise engaged (e.g. push to talk). Typically, the push-to-talk toggle 211 is a depressible switch on the side of a walkie-talkie style handheld communications device. In this way, a user's thumb may press the button to speak, then release the button when speaking is complete. It is placed to make this process simple and require relatively little force and to enable operation with a single hand. However, its placement and typically spring-loaded depression means inadvertent engagement with the push-to-talk toggle 211 of this form is common as discussed above.

The push-to-talk lock toggle 213 is a switch, button, software setting, on-display button or setting, or other mechanism used to disable the push-to-talk toggle 211 until this toggle 213 is disabled. The push-to-talk lock toggle 211 is preferably a switch, near the push-to-talk toggle 211 that disables the microphone and/or the push-to-talk toggle 211 until such time as the push-to-talk lock toggle 211 is disabled. The push-to-talk lock toggle 213 may be removed from the push-to-talk toggle 211 intentionally, e.g. on the face of the communications device or on its back, to make it more difficult—and thereby require more intentional interaction—to disable the push-to-talk lock toggle 213.

In some cases, the push-to-talk lock toggle 213 may cover or otherwise block access to a push-to-talk toggle 211. In other cases, it may merely be another button or switch that maintains its state until it is activated a second time (to enable or disable it). In other cases, the push-to-talk toggle 211 and the push-to-talk lock toggle 213 may be implemented fully or entirely in software. In such cases, the push-to-talk lock toggle 213 may be represented by a “button” displayed on a display screen and a touch-screen display. The user may be required to interact more than simply depressing the button on the display, and may, instead, be required to hold down a finger on the button for a second or more to disable or enable the push-to-talk lock toggle 213. Enabling may be a simple press, while disabling may require aa longer press or holding the button for a time (whether a physical or non-physical button). This is to make it more-difficult to inadvertently disable the push-to-talk lock toggle 213.

The microphone jack 215 is an optional component that enables a user to connect a wired headset with or without an integrated microphone. In this way, the communications device A 110 may enable its use without physically holding the communications device to one's face to speak or hear what is being communicated.

The display 216 is another optional component that may display functions, software-operated buttons, battery status (if any), associated channels being broadcast and listened on, and other information relevant to a user. The display 216 may merely be a display or may incorporate a touchscreen capability to enable interaction with the communications device A 110.

The Bluetooth/wireless connectivity 217 is another optional component that is a chip or a part of a system-on-a-chip or multiple components that enable the communications device A 110 to communicate with other devices (e.g. a Bluetooth® headset) near the communications device A 110. It may act in much the same way as the microphone jack 215, to enable a secondary device to capture audio and/or reproduce audio for transmission by the radio transceiver 210.

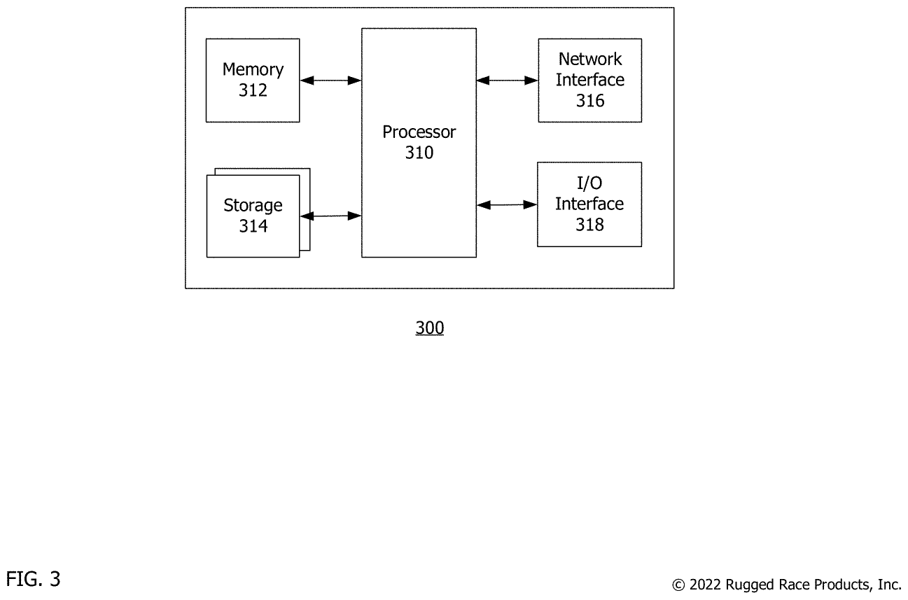

The computing device 218 is another optional component that is a computing device (FIG. 3) that may enable some or all of the functionality of the communications device A 110 to be enabled through software. It may be used to perform some or all of the functions described herein. It may also enable the touchscreen functionality to drive the display and alter the operation of the communications device A 110 in response to its programming—including the functionality associated with the push-to-talk toggle 211 and the push-to-talk lock toggle 213.

Turning to FIG. 3 a block diagram of a computing device 300 is shown. The computing device 400 may be representative of the server computers, client devices, mobile devices and other computing devices discussed herein. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 may have a processor 310 coupled to a memory 312, storage 314, a network interface 316 and an I/O interface 318. The processor 310 may be or include one or more microprocessors and application specific integrated circuits (ASICs).

The memory 312 may be or include RAM, ROM, DRAM, SRAM and MRAM, and may include firmware, such as static data or fixed instructions, BIOS, system functions, configuration data, and other routines used during the operation of the computing device 400 and processor 310. The memory 312 also provides a storage area for data and instructions associated with applications and data handled by the processor 310. As used herein, the word memory specifically excludes transitory medium such as signals and propagating waveforms.

The storage 314 may provide non-volatile, bulk or long-term storage of data or instructions in the computing device 300. The storage 314 may take the form of a disk, tape, CD, DVD, SSD, or other reasonably high capacity addressable or serial storage medium. Multiple storage devices may be provided or available to the computing device 300. Some of these storage devices may be external to the computing device 300, such as network storage or cloud-based storage. As used herein, the word storage specifically excludes transitory medium such as signals and propagating waveforms.

The network interface 316 is responsible for communications with external devices using wired and wireless connections reliant upon protocols such as 802.11x, Bluetooth®, Ethernet, satellite communications, and other protocols. The network interface 316 may be or include the internet.

The I/O interface 318 may be or include one or more busses or interfaces for communicating with computer peripherals such as mice, keyboards, cameras, displays, microphones, and the like.

### Description of Processes

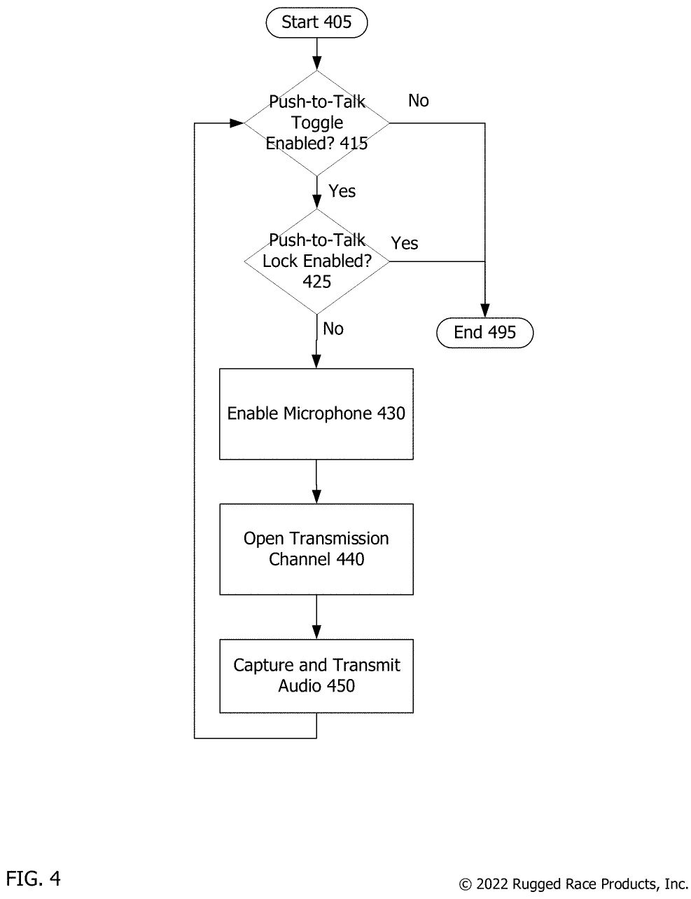

FIG. 4 is a flowchart of a method for use of a push-to-talk lock. The process begins at start 405 and ends at end 495, but it may take place many times or repeat many times before ending. Before this process begins, the user may or may not have enabled a push-to-talk lock toggle 213 (FIG. 2), depending on a desired setting for that component either to avoid inadvertent push-to-talk communications or to ensure that a user can operate the push-to-talk functionality unimpeded.

Following the start 405, a check is made to determine of the push-to-talk toggle is enabled at 415. This check may be periodic in the case of a computing device controlled communications device or may be triggered by activation of the push-to-talk toggle 415 (e.g. a push-to-talk button).

If the push-to-talk toggle is not enabled (“no” at 415), then the process ends.

If the push-to-talk toggle is enabled (“yes” at 415), then the process continues to 425. This push-to-talk toggle is most likely a physical button on the side or face of a walkie-talkie style device, but may take other forms, including involving software functions.

As a next step, a determination is made whether the push-to-talk lock is enabled at 425. If it is (“yes” at 425), then the process ends. This is the point at which the push-to-talk lock toggle 213 (FIG. 2) operates to stop an inadvertent operation of the push-to-talk toggle 211 by a user.

If push-to-talk lock is not enabled (“no” at 425), then the microphone is enabled 430, transmission channels are opened at 440, and any audio in the area (e.g. a user's voice) are captured and transmitted at 450.

The process then repeats with a check to see if the push-to-talk toggle is enabled (or still enabled) at 415.

In this way, the push-to-talk lock operates to stop inadvertent operation of the push-to-talk toggle 415 and inadvertent filling of the channel with noise.

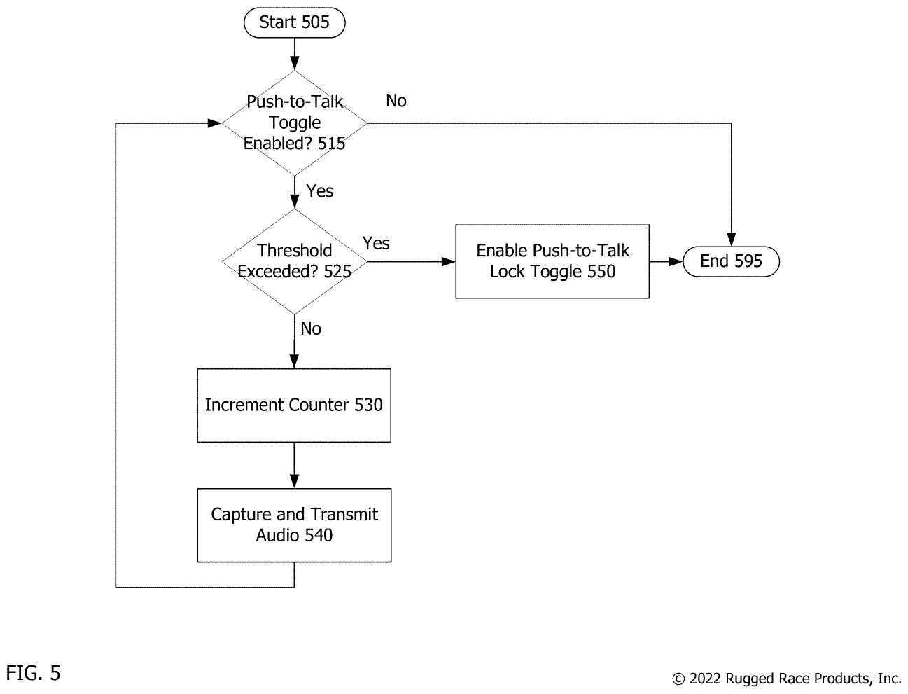

FIG. 5 is a flowchart of a method for use of a push-to-talk automatically engaging lock. The process begins at start 505 and ends at end 595, but it may take place many times or repeat many times before ending. Before this process begins, the user has not enabled a push-to-talk lock toggle 215 (FIG. 2). This auto-engagement preferably takes places in communications devices including at least a simple computing device for making the determinations discussed below.

Following the start at 505, a determination is first made at 515 whether the push-to-talk toggle has been enabled. This is typically a pushbutton to open a communication channel and a microphone for communications via the communications device, but may be software-based or shown on a display.

If not (“no” at 515), then the process ends at 595.

If the push-to-talk toggle has been enabled (“yes” at 515), then a determination is made whether a threshold has been exceeded at 525. This threshold is a selected one of a total time that the push-to-talk toggle has been enabled or is a number of times within a certain amount of time that the push-to-talk toggle has been enabled. These types of activities generally signify that a user is inadvertently activating the push-to-talk functionality.

If the threshold has not been exceeded (“no” at 525), then a counter is incremented at 530. This counter is intended to allow the user to operate the communications device normally without interruption, but to detect unusual or inadvertent use. The counter may merely be a total time that the push-to-talk toggle has been engaged or may be a total number of times within a predetermined period that the push-to-talk toggle has been engaged.

Continuing, once the counter is incremented at 530, audio is captured and transmitted at 540 as normal operation of the communications device and the process continues to the determination at 515 of whether the push-to-talk toggle is enabled.

This time, when the determination is made whether the threshold has been exceeded at 525, assuming it has (e.g. the predetermined number of seconds of push-to-talk toggle engagement has been reached), then the push-to-talk lock toggle is enabled automatically at 550. This turns on the push-to-talk lock thereby stifling further inadvertent push-to-talk engagement by this user of this communications device. If the user still wishes to use the communications device, the user may disengage the push-to-talk lock toggle to continue.

The process then ends at 595.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A communication device, comprising:
a radio transceiver for transmitting and receiving radio transmissions;
a push-to-talk toggle, integral to the communication device, for enabling capture and transmission of audio when the push-to-talk toggle is engaged and for disabling capture and transmission of audio when the push-to-talk toggle is disengaged; and
a push-to-talk lock toggle, integral to the communication device, for disabling capture and transmission of audio and disabling engagement of the push-to-talk toggle while the push-to-talk lock toggle is enabled.

2. The communication device of claim 1 wherein the push-to-talk toggle is a selected one of a physical button electrically connected to the communication device, a button displayed on a display screen, and a software toggle.

3. The communication device of claim 1 wherein push-to-talk lock toggle is a selected one of a physical button electrically connected to the communication device, a physical switch electrically connected to the communication device, a setting displayed on a display screen, and a software toggle.

4. The communication device of claim 1 wherein enabling the push-to-talk lock toggle further disables at least one of changing a communications channel and altering a volume of the communication device while the push-to-talk lock toggle is enabled.

5. The communications device of claim 1 wherein enabling the push-to-talk lock toggle only disables the push-to-talk toggle.

6. The communications device of claim 1, wherein the communications device is a selected one of: a handheld radio transceiver, a helmet-integrated radio transceiver, a wired or wireless headset in communication with a handheld or portable radio transceiver, a wrist-mounted radio transceiver, and a mobile telephone.

7. The communications device of claim 1 wherein the push-to-talk lock toggle is a physical button or switch and is recessed within the communications device to prevent inadvertent enablement or disablement of the push-to-talk lock toggle.

8. The communications device of claim 1 further comprising software, operating on a processor and associated memory, programmed to:
detect enablement of the push-to-talk toggle for a period exceeding a predetermined threshold; and
automatically enable the push-to-talk lock toggle after the predetermined threshold has been met.

9. The communications device of claim 1 further comprising:
a microphone for capturing audio;
a speaker for generating audio in response to signals received from the radio transceiver;
an antenna, connected to the radio transceiver, for capturing radio waves and providing the radio waves to the transceiver; and
an enclosure for protecting components making up the communications device.

10. The communications device of claim 9 in the form of a selected one of: a handheld radio transceiver, a helmet-integrated radio transceiver, a wired or wireless headset in communication with a handheld or portable radio transceiver, a wrist-mounted radio transceiver, and a mobile telephone.

11. A communications device comprising:
a radio transmitter for transmitting radio signals;
a microphone for capturing audio;
a push-to-talk toggle for enabling and disabling capture of audio using the microphone;
a push-to-talk lock toggle that disables capture of audio using the microphone and disabling the push-to-talk toggle when engaged; and
a housing for enclosing and protecting components of the communications device.

12. The communications device of claim 11 further comprising:
a radio receiver for receiving radio signals and converting them into electrical signals representative of audio;
a speaker for outputting the electrical signals as audio; and
wherein the radio receiver and the speaker continue to function while the push-to-talk lock toggle is engaged.

13. The communication device of claim 11 wherein enabling the push-to-talk lock toggle further disables at least one of changing a communications channel and altering a volume of the communication device while the push-to-talk lock toggle is enabled.

14. The communications device of claim 11 wherein enabling the push-to-talk lock toggle only disables the push-to-talk toggle.

15. The communications device of claim 11 wherein the push-to-talk toggle and the push-to-talk lock toggle are a selected one of: a physical button electrically connected to the communication device, a physical switch electrically connected to the communication device, a setting displayed on a display screen, and a software toggle.

16. The communications device of claim 11 further comprising software, operating on a processor and associated memory, programmed to:
detect enablement of the push-to-talk toggle for a period exceeding a predetermined threshold; and
automatically enable the push-to-talk lock toggle after the predetermined threshold has been met.

17. A communications device comprising:
a radio transceiver, integral to the communications device, for sending and receiving radio waves and for converting radio waves into electrical signals;
an antenna for capturing radio waves and providing them to the transceiver;
a microphone for capturing and converting audio to electrical signals for transmission;
a speaker for converting received electrical signals into audio;
a push-to-talk button for enabling audio capture by the microphone when depressed;
a push-to-talk lock switch for disabling audio capture by the microphone, whether or not the push-to-talk button is depressed; and
a case enclosing each of the foregoing components therewithin.

18. The communications device of claim 17 further comprising software, operating on a processor and associated memory, programmed to:
detect enablement of the push-to-talk button for a period exceeding a predetermined threshold; and
automatically enable the push-to-talk lock switch after the predetermined threshold has been met.

19. The communications device of claim 17 wherein the case is in the form of a selected one of a handheld radio transceiver, a headset radio transceiver, and a helmet-integral radio transceiver

20. The communications device of claim 17 wherein enabling the push-to-talk lock toggle further disables at least one of changing a communications channel and altering a volume of the communication device.
